(19) United States
(12) Patent Application Publication
(10) Pub. No.: US 2016/0090965 A1
(43) Pub. Date: Mar. 31, 2016

(54) WIND PARK AND METHOD FOR CONTROLLING A WIND PARK

(71) Applicant: WOBBEN PROPERTIES GMBH, Aurich (DE)

(72) Inventors: Kai BUSKER, Großefehn (DE); Alfred BEEKMANN, Wiesmoor (DE)

(21) Appl. No.: 14/786,355

(22) PCT Filed: Apr. 9, 2014
(86) PCT No.: PCT/EP2014/057141

§ 371 Date: Oct. 22, 2015

(30) Foreign Application Priority Data
Apr. 22, 2013 (DE) 10 2013 207 209.0

(51) Int. Cl. F03D 7/02; G05B 15/02; F03D 7/04

(52) U.S. Cl. CPC F03D 7/0264; F03D 7/048; G05B 15/02

(57) ABSTRACT

A wind farm having a central wind farm control unit, a plurality of wind energy installations and a data bus for coupling the central wind farm control unit to the plurality of wind energy installations is provided. Each of the wind energy installations has a control unit which is configured to control the operation of the wind energy installation independently of the central wind farm control unit if a fault occurs in the central wind farm control unit and/or a fault occurs on the data bus. The control unit is configured to successively switch off the respective wind energy installations.

### BACKGROUND

1. Technical Field

The present invention relates to a wind farm and to a method for controlling a wind farm.

2. Description of the Related Art

A wind farm is composed of a plurality of wind energy installations which can be controlled via a central control unit (Farm Control Unit FCU).

In the German patent application on which the priority is based, the German Patent and Trademark Office searched the following documents: DE 10 2009 042 368 A1; GB 2 475 609 A; U.S. Pat. No. 6,853,292 B1 and U.S. 2007/0124025 A1.

### BRIEF SUMMARY

One or more embodiments of the present invention provide a wind farm having a plurality of wind energy installations and a central control unit which can react in an improved way to faults within the wind farm.

A wind farm having a central wind farm control unit, a plurality of wind energy installations and a data bus for coupling the central wind farm control unit to the plurality of wind energy installations is therefore provided. Each of the wind energy installations has a control unit which is configured to control the operation of the wind energy installation independently of the central wind farm control unit if a fault occurs in the central wind farm control unit and/or a fault occurs on the data bus. The control unit is configured to successively switch off the respective wind energy installations.

According to one aspect of the present invention, the control unit is configured to switch off the respective wind energy installation after a time, defined in advance for these wind energy installations after the occurrence of the fault, if a fault occurs on the data bus or in the central wind farm controller.

One embodiment of the invention relates to a method for controlling a wind farm which has a central wind farm control unit, a plurality of wind energy installations and a data bus for coupling the central wind farm control unit to the plurality of wind energy installations. The operation of the wind energy installation is controlled by means of the control unit of the wind energy installation, independently of the central wind farm control unit, if a fault occurs in the central wind farm control unit and/or a fault occurs on the data bus. The respective wind energy installations are successively switched off by means of the control unit.

The other embodiment of the invention relates to a wind farm having a plurality of wind energy installations and a central wind farm controller. The central wind farm controller is connected to the respective wind energy installations via a data bus and can control the respective wind energy installations or influence the control of the wind energy installations. If a fault occurs in the central wind farm control unit and/or if a fault occurs on the data bus, each of the wind energy installation changes into a default operating mode in which a procedure for powering down the wind energy installations is stored. The respective wind energy installations are not all powered down simultaneously in the case of a fault within the wind farm. Instead, cascaded powering down or switching off of the wind energy installations takes place. As a result, a defined time interval is present between the switching off of adjacent wind energy installations. This is advantageous because in this way one wind energy installation can be switched off after the other, and the entire wind farm is not disconnected from the energy supply network at once.

If a fault is present in the central wind farm controller and/or on the data bus, the wind energy installations respectively switch into a default operating mode. The logic for the default operating mode can be stored in each of the wind energy installations. In the default operating mode, there is optionally no active control of the wind energy installations in order to generate electrical power. Instead cascaded switching off of the wind energy installations in the wind farm takes place.

Further refinements of the invention are the subject-matter of the dependent claims.

### BRIEF DESCRIPTION OF THE SEVERAL VIEWS OF THE DRAWINGS

Advantages and exemplary embodiments are explained in more detail below with reference to the drawings, in which:

FIG. 1 shows a schematic illustration of a wind energy installation according to the invention, and

FIG. 2 shows a schematic block diagram of a wind farm according to a first exemplary embodiment.

### DETAILED DESCRIPTION

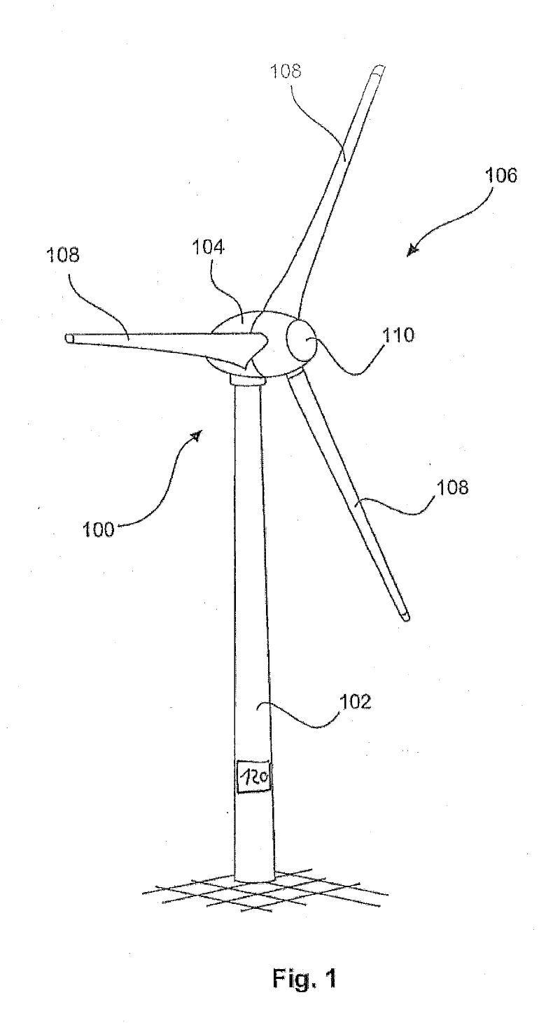

FIG. 1 shows a schematic illustration of a wind energy installation according to the invention. The wind energy installation 100 has a tower 102 and a gondola 104. A rotor 106 with three rotor blades 108 and a spinner 110 is provided on the gondola 104. The rotor 106 is made to rotate by the wind during operation and as a result has an electric generator in the gondola 104. The pitch of the rotor blades 108 can be changed by pitch motors at the rotor blade roots of the respective rotor blades 108.

The wind energy installation can also have a control unit 120 for controlling the operation of the wind energy installation. In a normal operating mode, the wind energy installation is controlled by means of the control unit 120 as a function of the prevailing wind in order to generate electrical power. As the wind speed becomes higher, the rotation speed of the rotor 106 of the wind energy installation also increases and therefore also the electrical power which is generated by the generator. From the time when the rated wind speed is reached and when the wind speed increases the attitude angle or the pitch of the rotor blades 108 is adjusted so that the wind energy installation 100 does not output more than the rated power to a supply network.

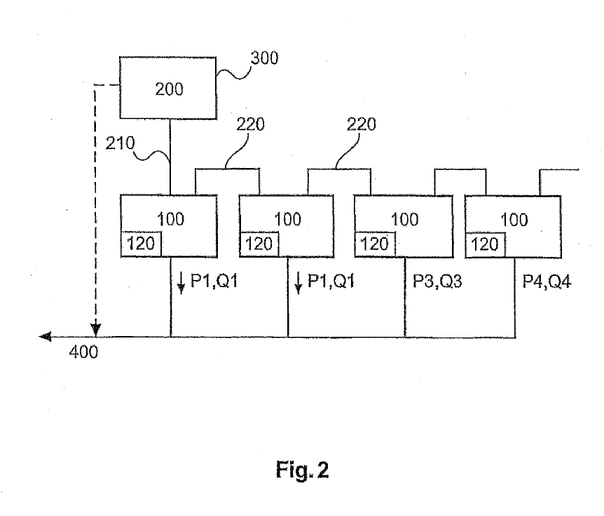

FIG. 2 shows a schematic illustration of a wind farm according to a first exemplary embodiment. The wind farm has a central wind farm control unit (Farm Control Unit FCU) 200 as well as a plurality of wind energy installations 100. The central wind farm control unit 200 can be connected to a Supervisory Control and Data Acquisition (SCADA) system 300 in order to exchange data. The central wind farm control unit 200 is connected to the wind energy installations 100 via a data bus 210, 220. The wind energy installations 100 are each connected separately or via a central feed point (Point of common coupling pcc) to a supply network 400 and each feed active power P and/or reactive power Q into the supply network 400.

The central wind farm control unit 200 receives data relating to the network voltage, network frequency and/or other network parameters and, if appropriate, further parameters of the supply network 400 and controls the wind energy installations 100 accordingly.

If a fault occurs in the central wind farm control unit 200 and/or on the data bus 210, 220, the wind energy installations 100 are configured to exit the normal operating mode and switch over into a default operating mode or fault operating mode. The control of the wind energy installations 100 in a default operating mode or fault operating mode can be provided, for example, in the control unit 120 of the wind energy installations. When a fault occurs in the central wind farm control unit 200 and/or on the data bus 210, 220, all the wind energy installations 100 in the wind farm must be deactivated or switched off. According to the first exemplary embodiment, this switching off will, however, not take place simultaneously but rather with staggered timing so that the entire wind farm is not disconnected from the network at once, which could lead to fluctuations in the network voltage and network frequency.

In the default operating mode or fault operating mode, the wind energy installations are disconnected from the network (for this purpose the rotor blades can be adjusted in such a way that the rotor is braked and finally comes to a standstill) and optionally there may be no active control of the wind energy installations (according to the normal operating mode). A parameter for the default operating mode represents the time when each of the wind energy installations 100 needs to be switched off. In this case, each of the wind energy installations 100 in the wind farm can have a number. For example, the number of the wind energy installation can be multiplied by a delay time in order to determine the respective switch-off time. If the delay time is, for example, 30 seconds, the first wind energy installation will be switched off after 30 seconds, and the second wind energy installation after 60 seconds and so on. As a result, cascaded switching off of the wind energy installations can be made possible, and the entire wind farm is therefore not switched off at once but instead the respective wind energy installations are switched off successively.

If a fault or an internal fault is detected in the central wind farm control unit 200, a corresponding signal can be transmitted to the respective wind energy installations 100 via the data bus 110, 120. As soon as a wind energy installation 100 receives a corresponding signal, the control unit 120 of the wind energy installation activates a default operating mode or fault operating mode. This default operating mode or pre-setting operating mode is provided so that in the event of a fault the wind energy installation can be safely powered down and stopped. In this default operating mode, the wind energy installation 100 is controlled by the control unit 120. The central wind farm control unit then no longer has any influence on the control of the respective wind energy installations 100.

The wind energy installation 100 can detect a fault on the data bus 210, 220, and the control unit 120 of the wind energy installations 100 then activates the default operating mode and the wind energy installation is switched off or powered down independently of the central wind farm control unit 200.

From the time when a fault is detected in the central wind farm control unit 200 and/or a fault is detected on the data bus 210, 220, a counter can optionally begin to run in each of the wind energy installations 100. After the expiry of the switch-off time assigned to each wind energy installation, each of the wind energy installations 100 is switched off or powered down by the control unit 120.

1. A wind farm, comprising:
a central wind farm control unit,
a plurality of wind energy installations,
a data bus coupling the central wind farm control unit to the plurality of wind energy installations,
wherein each of the wind energy installations has a control unit configured to control the operation of the wind energy installation independently of the central wind farm control unit in a fault operating mode when a fault occurs in, at least one of, the central wind farm control unit and the data bus,
wherein when the control units are operating in the fault operating mode, the control units are configured to successively switch off the respective wind energy installations of the plurality of wind energy installations.

2. The wind farm according to claim 1, wherein the control units are configured to switch off the respective wind energy installation at a predetermined time period after the fault occurs, the predetermined time period of time for each of the wind energy installations being different from each other.

3. A method for controlling a wind farm that includes a central wind farm control unit and a plurality of wind energy installations, wherein the central wind farm control unit is coupled to the plurality of wind energy installations via a data bus, the method comprising:
controlling the plurality of wind energy installations using the central wind farm control unit;
detecting a fault in at least one of the data bus and the central wind farm control unit,
in response to detecting the fault, controlling the wind energy installations using control units, respectively, wherein controlling the wind energy installations using the control units is independent of the central wind farm control unit; and
successively switching off the respective wind energy installations using the control units.

4. The method according to claim 3, wherein successively switching off the respective wind energy installations using the control units comprises switching off the wind energy installations at successive predetermined time intervals.

5. The method according to claim 4, wherein the successive predetermined time intervals are 30 seconds apart.

6. The wind farm according to claim 1, wherein each of the control units are configured to switch off the respective wind energy installation after a predetermined time period, wherein the predetermined time period is different for each wind power installation.
